(19) United States
(12) Patent Application Publication
(10) Pub. No.: US 2021/0114686 A1
(43) Pub. Date: Apr. 22, 2021

(54) SYSTEM AND METHOD FOR CONTROLLING AN ELECTRIC BICYCLE

(71) Applicant: GM GLOBAL TECHNOLOGY OPERATIONS LLC, DETROIT, MI (US)

(72) Inventors: George Floarea, Whitby (CA); Radu D. Sotir, Richmond Hill (CA)

(21) Appl. No.: 16/658,826

(22) Filed: Oct. 21, 2019

(51) Int. Cl. B62M 6/50; B62M 6/60

(52) U.S. Cl. CPC B62M 6/50; B62M 6/60

(57) ABSTRACT

A vehicle includes a road wheel and a crank configured to receive operator torque and provide crank power to the road wheel. A torque sensor is operatively coupled to the crank and configured to detect operator torque at the crank. A cadence sensor is operatively coupled to the crank and configured to detect a rotational speed of the crank. A motor is drivingly coupled to the road wheel and configured to selectively provide motor power to the road wheel. A controller is configured to control the motor power based on a target wheel speed of the road wheel. The controller is further configured to establish the target wheel speed based on the operator torque in response to the rotational speed being below a predefined threshold and to establish the target wheel speed based on the rotational speed in response to the rotational speed being at or above the predefined threshold.

The field to which the disclosure generally relates to includes electric cycles having pedal force-based propulsion systems.

Electric bicycles are increasing in popularity. Such bicycles typically include conventional bicycle components integrated with an electric motor that may be used for propulsion, including assisting or supplementing the pedal power supplied by the rider.

### SUMMARY

A vehicle according to the present disclosure includes a road wheel and a crank drivingly coupled to the road wheel. The crank is configured to receive operator torque and provide crank power to the road wheel. The vehicle additionally includes a torque sensor operatively coupled to the crank and configured to detect operator torque at the crank. The vehicle also includes a cadence sensor operatively coupled to the crank and configured to detect a rotational speed of the crank. The vehicle further includes a motor drivingly coupled to the road wheel and configured to selectively provide motor power to the road wheel. The vehicle still further includes a controller in communication with the torque sensor, the cadence sensor, and the motor. The controller is configured to control the motor power based on a target wheel speed of the road wheel. The controller is further configured to establish the target wheel speed based on the operator torque in response to the rotational speed being below a predefined threshold and to establish the target wheel speed based on the rotational speed in response to the rotational speed being at or above the predefined threshold.

In an exemplary embodiment, the vehicle also includes a generator operatively coupled to the crank. The generator is configured to selectively generate electricity in response to operator torque at the crank. The controller is further configured to control the generator to generate electricity in response to the rotational speed being at or above the predefined threshold. In such embodiments, the generator may be arranged concentrically with the crank.

In an exemplary embodiment, the crank is drivingly coupled to the road wheel via a single-speed transmission.

In an exemplary embodiment, the motor is arranged concentrically with a hub of the road wheel.

In an exemplary embodiment, the predefined threshold is 40 RPM. In an alternative exemplary embodiment, the predefined threshold is a user-defined threshold.

A method of controlling a vehicle according to an embodiment of the present disclosure includes providing the vehicle with a road wheel, a crank drivingly coupled to the road wheel and configured to receive operator torque and provide crank power to the road wheel, a torque sensor configured to detect operator torque at the crank, a cadence sensor configured to detect a rotational speed of the crank, a motor drivingly coupled to the road wheel and configured to selectively provide motor power to the road wheel, and a controller in communication with the torque sensor, the cadence sensor, and the motor. The method also includes, in response to a signal from the cadence sensor indicating that the rotational speed is below a predefined threshold, establishing a target wheel speed of the road wheel, via the controller, based on the operator torque. The method additionally includes, in response to a signal from the cadence sensor indicating that the rotational speed being at or above the predefined threshold, establishing the target wheel speed, via the controller, based on the rotational speed. The method further includes automatically controlling power of the motor, via the controller, based on the target wheel speed.

In an exemplary embodiment, the method also includes providing a generator configured to selectively generate electricity in response to operator torque at the crank. Such embodiments also include, in response to the rotational speed being at or above the predefined threshold, automatically controlling the generator, via the controller, to generate electricity. In such embodiment, providing a generator may include arranging the generator concentrically with the crank.

In an exemplary embodiment, providing a crank drivingly coupled to the road wheel includes drivingly coupling the crank to the road wheel via a single-speed transmission.

In an exemplary embodiment, providing a motor includes arranging the motor concentrically with a hub of the road wheel.

In an exemplary embodiment, the predefined threshold is 40 RPM. In an alternative embodiment, the predefined threshold is a user-definable value. Such embodiments may also include receiving an input from a user indicating a desired threshold and defining the predefined threshold, via the controller, in response to the input.

Embodiments according to the present disclosure provide a number of advantages. For example, the present disclosure provides a system for controlling an electric bicycle in an assist mode while providing a natural pedal feel at a range of speeds.

The above advantage and other advantages and features of the present disclosure will be apparent from the following detailed description of the preferred embodiments when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is an illustration of an electric cycle according to an embodiment of the present disclosure; and

FIG. 2 is a flowchart representation of a method of controlling a cycle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

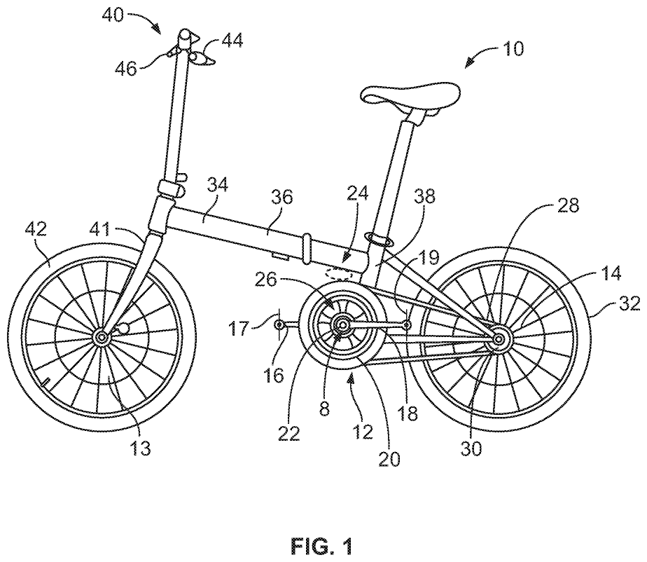

FIG. 1 illustrates an electric cycle 10 according to an embodiment of the precent disclosure. The electric cycle 10 includes a pedal force-based propulsion system, which allows the rider to provide intuitive input commands using foot pedals. The input commands are intuitive to the rider and are similar to riding a non-motorize bicycle wherein the rider applies a clockwise force to a bicycle crank by applying force to a forward positioned foot pedal to move the bicycle in a forward direction.

Reference herein as to a clockwise direction is made with respect to the right hand side of the cycle with an operator facing the forward direction of movement of the electric cycle.

The electric cycle 10 includes a cycle frame 34. The cycle frame 34 includes a top tube 36 connected to a seat tube 38. A wheel fork 41 is pivotably coupled to the top tube 36 and supports a front wheel 42 positioned at the fore of the electric cycle 10. Handlebars 40 are operatively connected to the front wheel 42 by way of the wheel fork 41. A rear wheel 32 is positioned at the aft of the electric cycle 10.

The electric cycle 10 includes a crank mechanism 8 configured to receive operator torque and provide crank torque to the rear wheel 32. The crank mechanism 8 includes a crankshaft 22 having a first pedal assembly 16 and a second pedal assembly 18 connected thereto. The first pedal assembly 16 may include a first foot pedal 17, and the second pedal assembly 18 may include a second foot pedal 19. A chain ring or sprocket 20 may be operatively connected to the crankshaft 22 for driving a chain 28 operatively connected to a rear sprocket 30 of a rear wheel 32. In an exemplary embodiment the sprockets 20, 30 and chain 28 define a single-speed transmission, i.e. having only a single sprocket 20 and a single sprocket 30 connected by the chain 28.

One or more sensors 26 are operatively coupled to the crank assembly 8 and/or the wheels 32, 42 and configured to detect operating conditions of the electric cycle 10. In an exemplary embodiment the sensors 26 include a wheel speed sensor configured to detect rotational speed of the wheels 32 and/or 42 (from which vehicle speed may be calculated), a cadence sensor configured to detect a rotational speed of the crank, and a torque sensor configured to detect operator torque applied at the crank.

The electric cycle 10 includes an electric motor/generator 14 which may be used to propel the electric cycle 10 forward and to generate electricity from motor braking. The motor/generator 14 is in electric communication with a battery assembly 13, and is configured to receive power therefrom when operating as a motor and provide power thereto when operating as a generator. The electric cycle 10 also includes a generator 12, e.g. a dynamo, operatively coupled to the crankshaft 22 and configured to generate electricity from actuation of the crankshaft 22 and provide power to the battery assembly 13.

In the illustrated embodiment the motor/generator 14 is mounted concentrically with the hub of the rear wheel 32 and configured to impart motor torque thereto. However, in other embodiments the motor/generator 14 may be positioned otherwise, e.g. at a hub of the front wheel 42, or adjacent the pedal assemblies 16, 18, chain ring 20 (or belt ring) and/or crankshaft 22. The motor/generator 14 may include any of a number of types of motor/generators including, but not limited to, a permanent magnet AC machine, either surface mount or interior permanent magnet rotor. In any of a number of variations, a brushless in runner ring motor/generator may comprise a stator and rotor.

In the illustrated embodiment the generator 12 is mounted concentrically with the crankshaft 22 and configured to receive torque directly therefrom. However, in other embodiments the generator 12 may be positioned otherwise, e.g. at the hub of the rear wheel 32.

In the illustrated embodiment the battery assembly 13 is depicted as a disc mounted concentrically with the hub of the front wheel 13. However, in other embodiments the battery assembly 13 may be positioned otherwise and/or may comprise a plurality of discrete battery packs.

Control levers 44 may be provided on the handlebars 40 and may be constructed and arranged to communicate with electronic controls 24 for controlling the motor/generator 14 and generator 12. The electronic controls 24 may include electronic processing components to receive input signals and to send out signals to control variation components of the cycle, which may include sending output signals to control operation of the electric motor/generator 12. In a number of variations the electronic controls 24 may include memory, a processor and software and/or hardware to process input signals and generate output signals, and may include formulas, lookup table or other means for comparing and processing data. A brake lever 46 may be also provided on the handlebars 40, if desired.

While depicted as a bicycle, in various embodiments within the scope of the present disclosure he electric cycle 10 may be a bicycle, tricycle, or four-wheel electric cycle having a crank assembly 8 constructed and arranged to allow a rider to provide input thereto using a first pedal assembly 16 and a second pedal assembly 18.

The electric cycle 10 may be configured to operate in various modes of operation, including at least one assist mode of operation wherein the electric motor/generator provides motor torque to the rear wheel 32 while an operator provides operator torque at the crankshaft 22. During such operation, it is desirable to provide the operator with a comfortable pedal feel. As examples, operators may prefer to maintain a crank cadence below approximately 70 RPM, and may also prefer some measure of torque response at the pedals 17, 19. Known methods of controlling electric cycles in an assist mode may result in uncomfortably fast pedal rotation, a lack of torque response, or both.

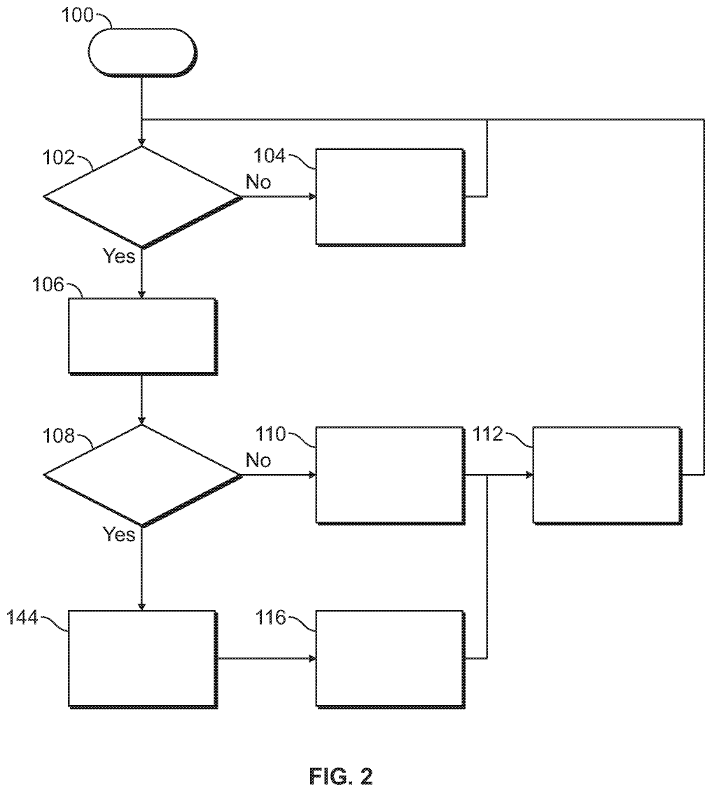

Referring now to FIG. 2, a method of controlling a cycle according to the present disclosure is illustrated in flowchart form. In an exemplary embodiment the method is performed via the controller 24 controlling the motor/generator 14 and generator 12 in response to signals from the sensors 26, as will be discussed in further detail below.

The method begins at block 100, e.g. when a user turns on the electric cycle 10. This may be performed in any suitable fashion, e.g. via the control levers 44, via a mobile device, or any other manner.

A determination is made of whether an assist mode is active, as illustrated at operation 102. As discussed previously, an assist mode refers to a mode wherein the electric motor/generator provides motor torque to the rear wheel 32 while an operator provides operator torque at the crankshaft 22. The operator may select a desired mode in any suitable fashion, e.g. via the control levers 44, via a mobile device, or any other manner.

In response to the determination of operation 102 being negative, i.e. some other mode being active, the cycle 10 is controlled according to the selected mode, as illustrated at block 104. Control then returns to operation 102. The cycle 10 is thereby controlled in a conventional manner unless and until the assist mode is activated.

In response to the determination of operation 102 being positive, i.e. the assist mode being active, then crank cadence, crank torque, and vehicle speed are detected, as illustrated at block 106. In an exemplary embodiment this is performed via signals from various sensors 26, including a torque sensor associated with the crank 26, a cadence sensor associated with the crank 26, and a wheel speed sensor associated with one or both wheels 32, 42. Vehicle speed may be calculated based on a radius of the wheel 32, 42 with which the speed sensor is associated.

A determination is made of whether the crank cadence exceeds a predefined threshold, as illustrated at operation 108. In an exemplary embodiment the predefined threshold is 40 RPM; however, higher or lower thresholds may be used as appropriate for a given configuration. In some embodiments the predefined threshold may be established by the operator, e.g. via the control levers 44, a mobile device in communication with the electronic controls 24, or through other suitable means.

In response to the determination of operation 108 being negative, i.e. the pedal cadence not exceeding the threshold, then a target speed for the electric cycle 10 is set based on the detected crank torque, as illustrated at block 110. This may be referred to as a torque-based control mode. In an exemplary embodiment, the target speed is determined via a first lookup table stored in nonvolatile computer memory, the first lookup table including a plurality of target speeds associated with a corresponding plurality of crank torques. Preferably, the target speed is directly proportional to the crank torque. In an exemplary embodiment, the maximum speed available in the torque-based control mode is approximately 18 kph.

The motor power is then controlled based on the target speed, as illustrated at block 112. This may be performed via any conventional scheme for controlling motor speed and/or torque based on a desired wheel speed, as appropriate for a given configuration. Control then returns to operation 102.

In response to the determination of operation 108 being positive, i.e. the pedal cadence exceeding the threshold, then a target speed for the electric cycle 10 is based on the detected pedal cadence, as illustrated at block 114. This may be referred to as a cadence-based control mode. In an exemplary embodiment, the target speed is determined via a second lookup table stored in nonvolatile computer memory, the second lookup table including a plurality of target speeds associated with a corresponding plurality of pedal cadence values. Preferably, the target speed is directly proportional to the pedal cadence. In an exemplary embodiment, the minimum speed available in the cadence-based control mode is approximately 18 kph, and the maximum speed available is approximately 32 kph. The maximum speed may correspond to approximately 70 RPM, with higher RPMs resulting in no additional speed increase.

At such speeds with a single-speed transmission, an operator will feel relatively little resistance torque at the crank. The generator 12 is therefore controlled to provide power, as illustrated at block 116. In an exemplary embodiment, the resistive torque provided by the generator is determined via a third lookup table stored in nonvolatile computer memory, the third lookup table including a plurality of resistive torques associated with a corresponding plurality of pedal cadence values. Alternatively, a generally constant resistive torque may be provided. Control then proceeds to block 112.

As may be seen, the present disclosure provides an electric cycle capable of achieving a full operational speed range using a single speed driveline as opposed to having a multiple speed hub or a derailleur. Besides the benefit of simplifying the mechanical components, lower cost and mass, the user experience will benefit by not having to manually shift the gears to adjust the speed. This is especially useful in city riding during stop-and-go cycles.

As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
a road wheel;
a crank drivingly coupled to the road wheel and configured to receive operator torque and provide crank power to the road wheel;
a torque sensor operatively coupled to the crank and configured to detect operator torque at the crank;
a cadence sensor operatively coupled to the crank and configured to detect a rotational speed of the crank;
a motor drivingly coupled to the road wheel and configured to selectively provide motor power to the road wheel; and
a controller in communication with the torque sensor, the cadence sensor, and the motor, the controller being configured to control the motor power based on a target wheel speed of the road wheel, wherein the controller is further configured to establish the target wheel speed based on the operator torque in response to the rotational speed being below a predefined threshold and to establish the target wheel speed based on the rotational speed in response to the rotational speed being at or above the predefined threshold.

2. The vehicle of claim 1, further comprising a generator operatively coupled to the crank and configured to selectively generate electricity in response to operator torque at the crank, wherein the controller is further configured to control the generator to generate electricity in response to the rotational speed being at or above the predefined threshold.

3. The vehicle of claim 2, wherein the generator is arranged concentrically with the crank.

4. The vehicle of claim 1, wherein the crank is drivingly coupled to the road wheel via a single-speed transmission.

5. The vehicle of claim 1, wherein the motor is arranged concentrically with a hub of the road wheel.

6. The vehicle of claim 1, wherein the predefined threshold is 40 RPM.

7. The vehicle of claim 1, wherein the predefined threshold is a user-definable value.

8. A method of controlling a vehicle comprising:
providing the vehicle with a road wheel, a crank drivingly coupled to the road wheel and configured to receive operator torque and provide crank power to the road wheel, a torque sensor configured to detect operator torque at the crank, a cadence sensor configured to detect a rotational speed of the crank, a motor drivingly coupled to the road wheel and configured to selectively provide motor power to the road wheel, and a controller in communication with the torque sensor, the cadence sensor, and the motor;
in response to a signal from the cadence sensor indicating that the rotational speed is below a predefined threshold, establishing a target wheel speed of the road wheel, via the controller, based on the operator torque;
in response to a signal from the cadence sensor indicating that the rotational speed being at or above the predefined threshold, establishing the target wheel speed, via the controller, based on the rotational speed; and
automatically controlling power of the motor, via the controller, based on the target wheel speed.

9. The method of claim 8, further comprising:
providing a generator configured to selectively generate electricity in response to operator torque at the crank; and
in response to the rotational speed being at or above the predefined threshold, automatically controlling the generator, via the controller, to generate electricity.

10. The method of claim 9, wherein providing a generator comprises arranging the generator concentrically with the crank.

11. The method of claim 8, wherein providing a crank drivingly coupled to the road wheel comprises drivingly coupling the crank to the road wheel via a single-speed transmission.

12. The method of claim 8, wherein providing a motor comprises arranging the motor concentrically with a hub of the road wheel.

13. The method of claim 8, wherein the predefined threshold is 40 RPM.

14. The method of claim 8, wherein the predefined threshold is a user-definable value, further comprising receiving an input from a user indicating a desired threshold and defining the predefined threshold, via the controller, in response to the input.
